(19) United States
(12) Patent Application Publication
(10) Pub. No.: US 2026/0340606 A1
(43) Pub. Date: Oct. 29, 2026

(54) SYSTEMS AND METHODS FOR CASH BACK LOAN REWARDS

(71) Applicant: The PNC Financial Services Group, Inc., Pittsburgh, PA (US)

(72) Inventors: Victoria L. DRAVNEEK, Charlotte, NC (US); Adam McGOVERN, Bellefonte, PA (US); Joseph PERVEILER, Pittsburgh, PA (US)

(73) Assignee: The PNC Financial Services Group, Inc., Pittsburgh, PA (US)

(21) Appl. No.: 19/436,437

(22) Filed: Dec. 30, 2025

Related U.S. Application Data
(63) Continuation of application No. 19/418,278, filed on Dec. 12, 2025.
(60) Provisional application No. 63/792,982, filed on Apr. 23, 2025.

(51) Int. Cl. G06Q 20/10; G06Q 30/0207; G06Q 40/03

(52) U.S. Cl. CPC G06Q 20/10; G06Q 30/0215; G06Q 40/034

(57) ABSTRACT

A system is disclosed for issuing cash back loan rewards. The system may include at least one processor configured to execute the instructions to perform operations. The operations may include receiving an entity statement balance at an interval during a first period of time; transmitting the entity statement balance to a rewards calculator; calculating the cash back reward at a second period of time using the rewards calculator, which is configured to save cash back reward data into a service fabric layer, wherein the service fabric layer publishes the cash back reward data to a job processor service; and initiating an event to move the cash back reward to an entity account periodically at the second period of time, the job processor service configured to process a job asynchronously using a single thread and to maintain a log of a job's lifecycle.

### CROSS REFERENCE TO RELATED APPLICATIONS

This application claims the benefit of priority of U.S. Provisional Patent Application No. 63/792,982 filed on Apr. 23, 2025, the contents of which are incorporated herein by reference in their entirety.

### TECHNICAL FIELD

The present disclosure generally relates to systems and methods for improved cash back rewards and, more particularly, to systems and methods regarding cash back loan rewards.

### BACKGROUND

There are a variety of banking customer rewards and benefits programs where customers earn rewards through their relationship, actions, and inactions with their financial institution. Rewards and benefits programs such as customer affinity programs, payment instrument incentive programs, cash back rewards, and other similar programs are often used to develop and maintain customer loyalty, incentivize customers to use or purchase various products or services or use specific methods to make those purchases, incentivize customers to use a financial institution's services, help customers achieve their goals, and reward customers for continued good standing.

Generally, cash back rewards offerings are tied to the use of a credit card, where a customer gets a percentage of cash back on a qualifying purchase when they use a specific credit card. The customer pays their monthly statement and is rewarded for making purchases with the financial institution's credit card. The financial institution receives the benefit of the customer using its services, and the customer receives a benefit that would not exist had they paid with cash. Traditional cash back rewards system do not reward customers based on loans. Generally, pricing benefits on loans include rate reductions and cash back on closing costs. Traditional systems do not periodically rewards customers during the loan period for their continued loyalty, good standing, and efforts in paying off their loans. What is needed is a system for providing eligible enrolled customers with periodic cash back on their loans based on the principal of the loan and/or the customer's relationship with a company, such as a financial institution.

### SUMMARY

In view of the foregoing, embodiments of the present disclosure address disadvantages of existing conventional systems and methods by providing novel computer-implemented systems and methods for providing cash back loan rewards.

Embodiments of the present disclosure provide a computer implemented system for providing an entity with a cash back reward on a loan. A cash back rewards system may include a memory storing a set of instructions. The cash back rewards system may include a database in electronic communication with a memory. The cash back rewards system may include a plurality of processors in electronic communication with the database. The database may be configured to store information that includes corporate account information, customer information, and account and loan balance information. The corporate account information may be associated with a corporate account and customer information may be associated with at least one customer or customer accounts. The account and loan balance information may be associated with at least one account. The plurality of processors may be configured to execute a set of instructions. The set of instructions may include receiving an entity statement balance at an interval during a first period of time; transmitting the entity statement balance to a rewards calculator; calculating, using at least the entity statement balance, the cash back reward at a second period of time using the rewards calculator, the rewards calculator configured to save cash back reward data into a service fabric layer, wherein the service fabric layer periodically publishes the cash back reward data to at least one job processor service; and initiating, using the at least one job processor service, an event to move the cash back reward to an entity account periodically at the second period of time, the at least one job processor service configured to process a job asynchronously using a single thread and to maintain a log of a job's lifecycle.

In another embodiment, the set of instructions may include receiving, continuously, entity data and an average loan value into a service provider platform from a product benefits hub; determining, from the entity data and average loan value, whether an entity is eligible to receive a cash back reward, the entity being deemed eligible when the entity maintains good standing; performing, using at least the entity data and average loan value, a cash back reward calculation periodically using a rewards calculator, the rewards calculator configured to execute a preselected method for determining a cash back reward; monitoring the service provider platform for performance of a cash back reward calculation and receiving a cash back reward amount into the product benefits hub; and applying, using one or more job processor, the cash back reward amount against an entity's loan balance automatically.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

Throughout this disclosure the phrase “disclosed embodiments” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic. It is to be understood that both the foregoing general description and the following detailed description are exemplary and explanatory only, and are not restrictive of the disclosed embodiments, as claimed.

### BRIEF DESCRIPTION OF THE DRAWINGS

Embodiments and various aspects of the present disclosure are illustrated in the following detailed description and the accompanying figures. Various features shown in the figures are not drawn to scale. Identical reference numerals generally represent identical components in the exemplary implementations of the present disclosure.

FIG. 1 depicts an exemplary illustration of an entity using a computer to make loan payments.

FIG. 2 depicts an exemplary illustration of an entity using a rewards system, consistent with disclosed embodiments.

FIG. 3 depicts a block diagram showing an exemplary computing device, consistent with disclosed embodiments.

FIG. 4A depicts a portion of a flow diagram for providing cash back rewards on loans, consistent with disclosed embodiments.

FIG. 4B depicts a second portion of a flow diagram for providing cash back rewards on loans, consistent with disclosed embodiments.

FIG. 4C depicts a third portion of a flow diagram for providing cash back rewards on loans, consistent with disclosed embodiments.

FIG. 5A depicts a portion of another flow diagram for providing cash back rewards on loans, consistent with disclosed embodiments.

FIG. 5B depicts a second portion of another flow diagram for providing cash back rewards on loans, consistent with disclosed embodiments.

FIG. 5C depicts a third portion of another flow diagram for providing cash back rewards on loans, consistent with disclosed embodiments.

FIG. 6A depicts a portion of yet another flow diagram for providing cash back rewards on loans, consistent with disclosed embodiments.

FIG. 6B depicts a second portion of yet another flow diagram for providing cash back rewards on loans, consistent with disclosed embodiments.

FIG. 6C depicts a third portion of yet another flow diagram for providing cash back rewards on loans, consistent with disclosed embodiments.

FIG. 7A depicts a portion of another flow diagram for providing cash back rewards on loans, consistent with disclosed embodiments.

FIG. 7B depicts a second portion of another flow diagram for providing cash back rewards on loans, consistent with disclosed embodiments.

FIG. 7C depicts a third portion of another flow diagram for providing cash back rewards on loans, consistent with disclosed embodiments.

FIG. 8 depicts a flow chart of a process of issuing cash back rewards, consistent with disclosed embodiments.

FIG. 9 depicts a flow chart of another process of issuing cash back rewards, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limiting.

Embodiments herein include computer-implemented methods, tangible non-transitory computer-readable media, and systems. The computer-implemented methods may be executed, for example, by at least one processor (e.g., a processing device) that receives instructions from a non-transitory computer-readable storage medium. Similarly, systems consistent with the present disclosure may include at least one processor (e.g., a processing device) and a memory, and the memory may include a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, non-volatile memory, hard drives, compact disc (CD) ROMs, digital optical discs (DVDs), flash drives, disks, and/or any other known physical storage medium. Singular terms, such as “memory” and “computer-readable storage medium,” may additionally refer to multiple structures, such as a plurality of memories and/or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with an embodiment herein. Additionally, one or more computer readable storage mediums may be utilized in implementing a computer-implemented method. The term “computer-readable storage medium” should be understood to include tangible items and exclude carrier waves and transient signals.

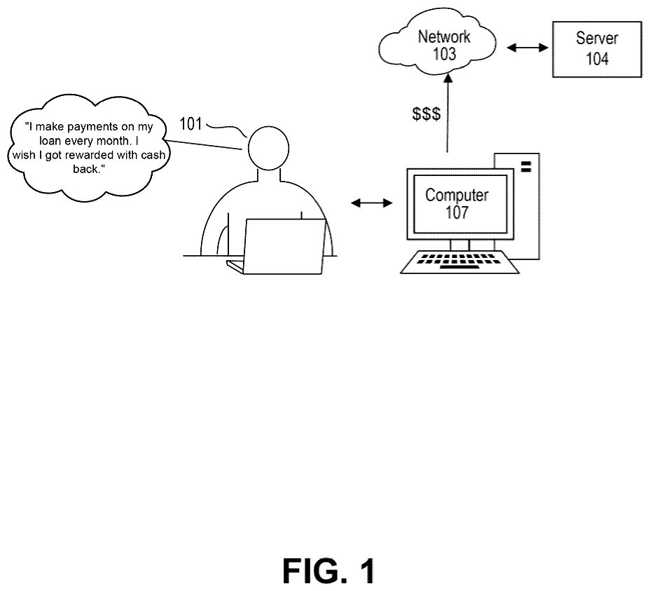

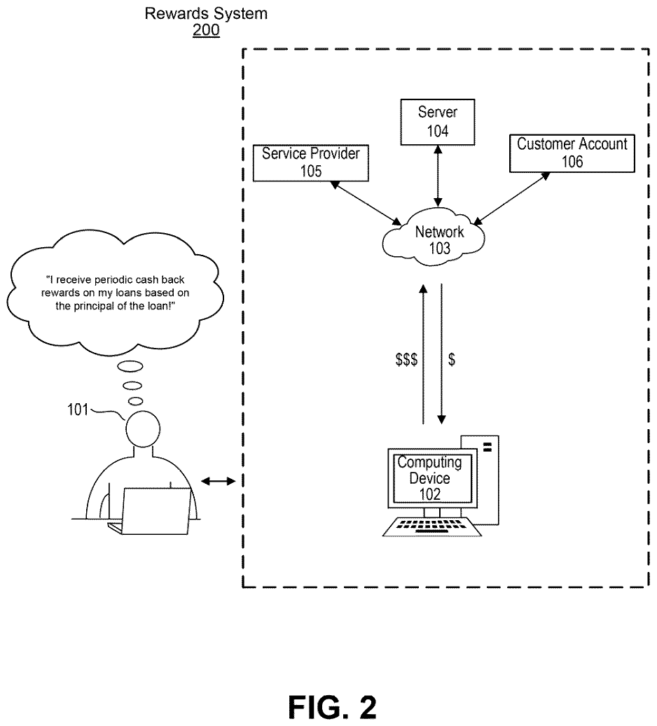

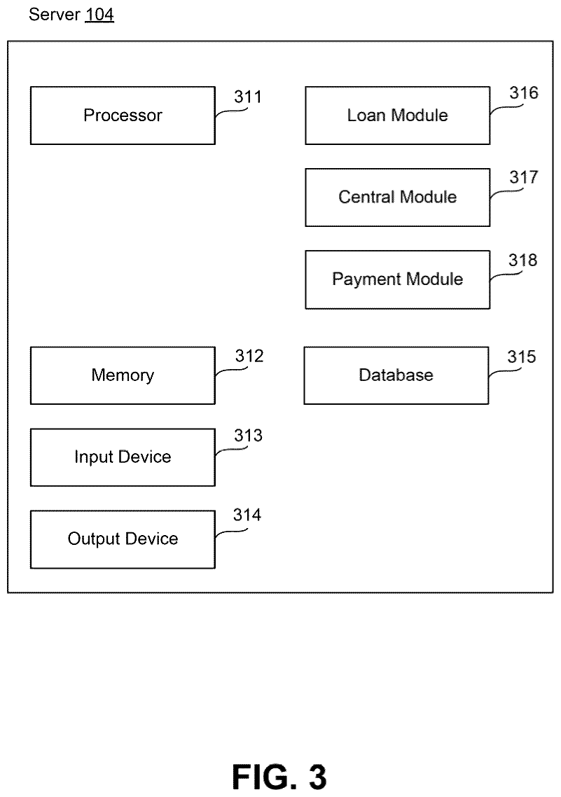

FIG. 1 depicts an exemplary illustration of entity 101 using computer 107 to make a loan payment in a conventional manner. Entity 101, as described herein, may be an individual, a team of individuals, a customer, a financial institution, or an organization. Entity 101 uses computer 107 to make the loan payment over network 103, as described with respect to FIG. 2. Entity 101 may log onto an account associated with the loan, view a current balance, select a payment method, and execute a transfer of funds to pay a portion of or the entirety of the current balance. Alternatively, entity 101 may set up an automatic payment schedule. The loan payment is then received and processed by a company's server 104, as described with respect to FIG. 3. The server 104 may mark the payment as received in the account associated with the loan, and the remaining loan balance may be updated to reflect the payment being received. Entity 101 may repeat this process monthly, for example, until the loan is fully repaid; however, entity does not receive any reward or benefit. As illustrated in FIG. 1, entity 101 thinks: “I make payments on my loan every month. I wish I got rewarded with cash back.”

FIG. 2 depicts an exemplary illustration of entity 101 using computing device 102 displaying rewards system 200. Entity 101 thinks: “I receive periodic cash back rewards on my loans based on the principal of the loan!” Cash back, as described herein, may refer to a rewards program where entity 101 receives a portion of their purchase or transaction amount back into a designated account. The portion is typically received in the form of a credit, for using a particular service or payment instrument. Entity 101, as illustrated in FIG. 2, then uses computing device 102 to view rewards system 200. Rewards system 200, as described herein, may refer to a system for providing customers with periodic cash back on their loans. Rewards system 200 may provide cash back to customers on a monthly, quarterly, bi-annual, or annual basis, or may use some other period.

Rewards system 200 may determine the cash back amount in a variety of ways. In one embodiment, rewards system 200 may calculate a flat-rate cash back, where the amount of cash back received is a preselected percentage of the principal of a loan or of a loan payment. In some embodiments, the principal of a loan may be an entity statement balance or entity loan balance. Entity statement balance, as described herein, may refer to the total amount of money entity 101 owes for a specific period. In another embodiment, the amount of cash back received may be tiered such that each loan payment earns entity 101 more cash back than the previous loan payment. In yet another embodiment, the amount of cash back may vary depending on when entity 101 makes the loan payment. For example, entity 101 may receive more cash back if entity 101 makes a loan payment ten days before the payment is due than if entity 101 makes a loan payment two days before the payment is due. In other embodiments, entity 101 may be assigned a cash back rewards tier that issues a lower cash back reward amount and, after continued timely loan repayment, may level up to higher cash back rewards tier that issues a higher cash back rewards amount. In yet another embodiment, rewards system 200 may evaluate entity's 101 relationship with the company to determine the amount of cash back entity 101 should receive. Several factors may contribute to reward system's 200 evaluation of entity's 101 relationship with the company. Such factors may include entity's 101 standing with the company, entity's 101 credit history, entity's 101 loan repayment history, the number of times entity 101 has made a late payment, and how long entity 101 has been a customer of the company. In yet another embodiment, rewards system 200 may use the amount of the principal of the loan to determine a cash back amount. In yet another embodiment, rewards system 200 may use an average loan value or average loan balance, such as an average daily loan value, or entity statement balance to determine a cash back amount. The average loan value, as described herein, may refer to a measure of the typical principal amount for loans in a portfolio during a specific extended period of time. The daily average loan value, as described herein, may refer to the typical outstanding principal balance of a loan over a specific period, such as a payment cycle or a month. Rewards system 200 may determine a rate of decline of the entity statement balance and may not issue the cash back amount if the rate of decline is below a preselected threshold rate of decline. The preselected threshold rate of decline, as described herein, may refer to a minimum rate at which the lender expects to be repaid or receive a return on their investment. If entity 101 is behind on their payments or does not pay for the full amount for a particular period, then the preselected threshold rate of decline may not be met, and entity may not receive a cash back reward. In other embodiments, rewards system 200 may use a combination of the above methods for determining the cash back amount.

Rewards system 200 may include network 103, server 104, service provider 105, and customer account 106. Various components of rewards system 200, including computing device 102, may communicate over network 103, as described herein, may refer to one or more environments in which relevant activities of entity 101 on computing device 102 may be recorded and stored for future viewing. The recording, transmission, and storage of the recorded entity activity may be performed in a secure manner, such that only a company and entity 101 may have access to the recorded activity.

Such communications over network 103 may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, communications may take place across two or more of these forms of networks and protocols. In other embodiments, network 103 may also be a localized system, with one or more of the components communicating directly with each other.

Server 104, as described herein, as further described in FIG. 3, may refer to one or more digital and/or analog devices that allow communication with other machines and devices. Computing device 102, server 104, service provider 105, and customer account 106 may communicate with one another over network 103.

Service provider 105, as described herein, may refer to one or more companies or individuals that offer specific services to a company or its customers. Service provider 105 may include entities such as payment service providers, Banking as a Service (BaaS) providers, or core banking software providers. In one embodiment, a payment service provider may be used to facilitate electronic payments for merchants or act as an intermediary between consumers, businesses, and companies, such as financial institutions. In another embodiment, banking as a service (BaaS) providers may be used to help businesses embed financial services into their platforms without needing their own banking infrastructure. In yet another embodiment, core banking service providers may be used to develop and provide software a company may use for their core operations, like managing accounts, loans, and payments.

In other embodiments, service provider 105 may help banks to accelerate time-to-market for new product offerings, personalize products and pricing, enhance customer experience, and achieve desirable outcomes. Service provider 105 may assist with a company increasing its business agility and accelerating its modernization journey. Modernization may help separate products and pricing from a core banking system to allow innovation without the need for a new core banking system. Service provider 105 may assist with defining rates and fees automatically based on client/customer attributes and help to improve customer value and steer customers to preferred behaviors or actions.

Customer account 106, as described herein, may refer to one or more records of financial information and transactions. Customer account 106 may also contain personal information about a customer such as name and birthday, or account information such as holdings, balances, when the account was opened, withdrawals, deposits, regular and irregular account activity, debts, automatic transaction settings, loans, payment history, and interest earned.

FIG. 3 depicts a block diagram showing an exemplary computational device, consistent with disclosed embodiments. Server 104 may include one or more dedicated processors and/or memories. For example, server 104 may include processor (or multiple processors) 311, and memory (or multiple memories) 312.

Processor 311 may take the form of, but is not limited to, a microprocessor, embedded processor, or the like, or may be integrated in a system on a chip (SoC). Furthermore, according to some embodiments, processor 311 may be from the family of processors manufactured by Intel®, AMD®, Qualcomm®, Apple®, NVIDIA®, or the like. Processor 311 may also be based on the ARM architecture, a mobile processor, or a graphics processing unit, etc. The disclosed embodiments are not limited to any one type of processor.

Memory 312 may include one or more storage devices configured to store instructions used by processor 312 to perform functions related to computing device 312. The disclosed embodiments are not limited to software programs or devices configured to perform dedicated tasks. For example, memory 312 may store a single program, such as a user level application, which performs the functions associated with the disclosed embodiments or may comprise multiple software programs. Additionally, processor 311 may, in some embodiments, execute one or more programs (or portions thereof) remotely located from server 104. Furthermore, memory 312 may include one or more storage devices configured to store data for use by the programs. Memory 312 may include, but is not limited to, a hard drive, a solid-state drive, a CD-ROM drive, a peripheral storage device (e.g., an external hard drive, a USB drive, etc.), a network drive, a cloud storage device, or any other storage device.

In some embodiments, server 104 may include an input device 313. Server 104 may include one or more digital and/or analog devices that allow communication with other machines and devices, such as other components of rewards system, as described with respect to FIG. 2. Server 104 may include one or more input device 313 or output device 314. Input device 313 may be configured to receive input from an entity, as described with respect to FIG. 2, e.g., the computing device, as described with respect to FIG. 2, and one or more components of server 104 may perform one or more functions in response to the input received. In some embodiments, input device 313 may include an interface displayed on a touchscreen (e.g., an output device 114). Output device 314 may include a screen for displaying communications to an entity. For example, output device 314 may include a display configured to display the information relating to the transaction. Server 104 may include other components known in the art for interacting with an entity. Output device 314 may also include one or more digital and/or analog devices that allow an entity to interact with the rewards system, as described with respect to FIG. 2, such as touch sensitive area, keyboard, buttons, or microphones.

In some embodiments, server 104 may include database 315. Database 315 may be included on a volatile or non-volatile, magnetic, semiconductor, tape, optical, removable, non-removable, or other type of storage device or tangible or non-transitory computer-readable medium. Database 315 may also be part of server 104 or separate from server 104. When database 315 is not part of server 104, server 104 may exchange data with database 315 via a communication link. Database 315 may include one or more memory devices that store data and instructions used to perform one or more features of the disclosed embodiments. Database 315 may include any suitable databases, ranging from small databases hosted on a workstation to large databases distributed among data centers. Database 315 may also include any combination of one or more databases controlled by memory controller devices (e.g., server(s), etc.) or software. For example, database 315 may include document management systems, Microsoft SQL™ databases, SharePoint™ databases, Oracle™ databases, Sybase™ databases, other relational databases, or non-relational databases, such as mongo and others.

In some embodiments, server 104 may include loan module 316. Loan module may manage all aspects of a loan's lifecycle, including application processing, underwriting, approval, repayment, and closure. It may assist with automating and streamlining processes associated with the loan, allowing a company to track, monitor, and control loan portfolios. In some embodiments, loan module 316 may include its own database, user interface, and integrations. In other embodiments, loan module 316 may utilize database 315 and output device 314 within server 104. Database 315 may store all relevant loan data, including customer details, loan term, repayment schedule, transaction history, and principal. In some embodiments, output device 314 may be a user interface. Output device 314 may allow loan officers to access and manage loan data, track repayment, flag issues, assess risk, and generate reports. Loan module integration may allow loan module 316 to communicate with other components of the server including central module 317 and payment module 318. In some embodiments, loan module 316 may periodically transmit loan data such as the principal of a customer's loan to central system 317. Loan module 316 may transmit data on a daily, weekly, monthly, quarterly, annual, or biannual basis, or based on some other period.

In some embodiments, server 104 may include central module 317. Central module 317 may handle essential functions such as account management, payments, loans, and accounting. Such functions may involve managing customer accounts, processing transactions, originating and servicing loans, maintaining financial records, complying with regulatory requirements, reconciliation, performing calculations, and evaluating customer and third-party relationships. In some embodiments, central module 317 may include its own processor, memory, and database, and in other embodiments, central module 317 may utilize processor 311, memory 312, and database 315 of server 104.

In some embodiments, central module 317 may evaluate a customer's relationship with a company on a periodic basis. Central module 317 may use a variety of factors to assess the relationship, and in some embodiments, central module 317 may assign a relationship score to a customer or customer account and record the score in database 315. In some embodiments, central module 317 may use factors such as repayment history, credit score, and how long the customer has been a customer of the company to evaluate the customer relationship. In some embodiments, central module 317 may overwrite the relationship score stored in database 315 each time the relationship is evaluated. In other embodiments, central module 317 may store each subsequent relationship score in database 315 and monitor how the relationship changes overtime. In some embodiments, central module 317 may receive loan data, including the principal of a customer's loan, from loan module 316. In some embodiments, central module 317 may determine a loan cash back percentage. In some embodiments, central module 317 may determine the loan cash back percentage based on the customer relationship, and in other embodiments, central module 317 may use the relationship score, relationship score history, or average relationship score over a period of time to calculate the loan cash back percentage. In some embodiments, central module 317 apply the loan cash back percentage to the principal of a customer's loan received from loan module 316 and send the resulting cash back amount and associated data to payment module 318. In some embodiments, central module 317 may send the resulting cash back amount and associated data to payment module 318 instantly, within the same day as the loan data is received from loan module 316, or in other embodiments, after some delay.

In some embodiments, server 104 may include payment module 318. Payment module 318 may facilitate and process transactions including those related to customer loan payments, repayments, and rewards. In some embodiments, payment module 318 may include its own processor, memory, and database, and in other embodiments, payment module 318 may utilize processor 311, memory 312, and database 315 of server 104. Payment module 118 may receive a cash back amount and associated data from central module 317. Payment module 318 may facilitate an event to move awarded funds in the amount of the cash back amount into a loan customer's designated account on a periodic basis. Such transaction may occur on a monthly, quarterly, biannual, or annual basis, or according to some other period.

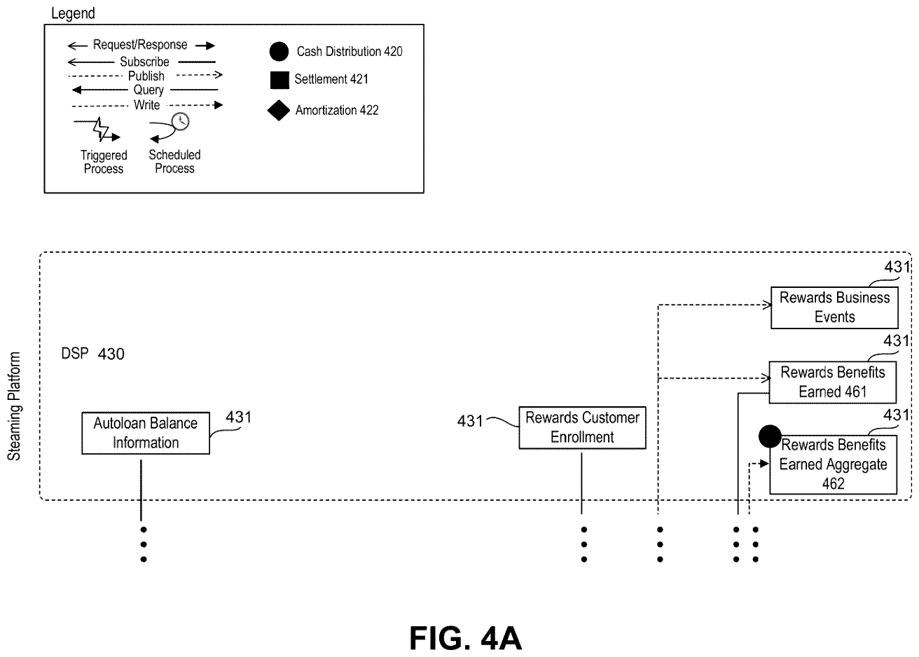

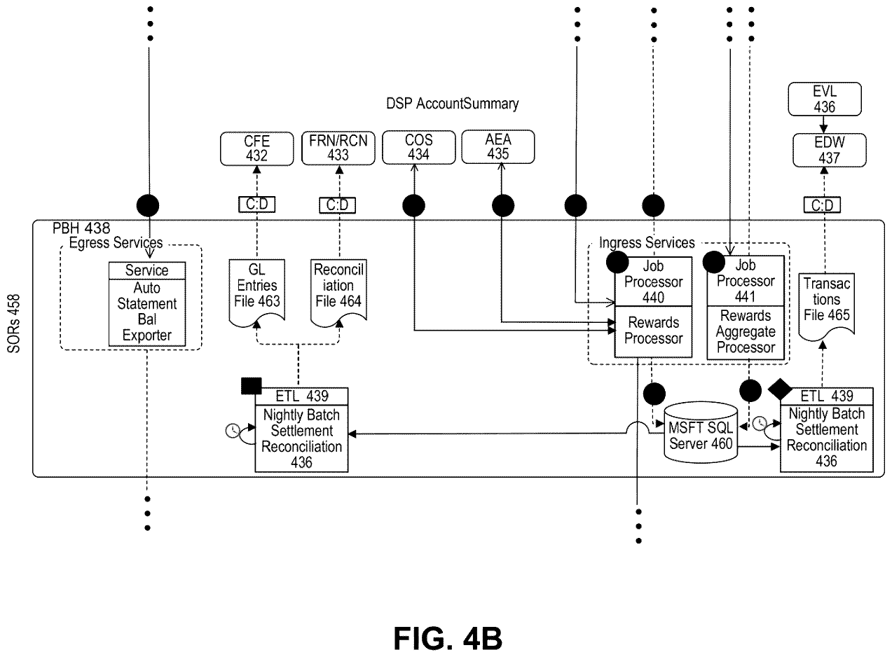

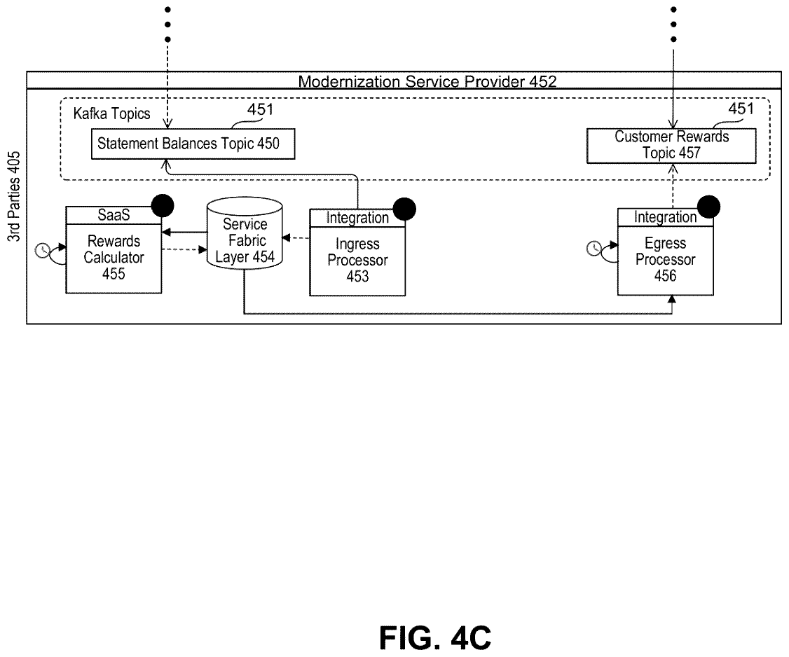

Each of FIGS. 4A, 4B, and 4C depict a portion of a flow diagram for providing cash back rewards on loans, such as automobile loans, consistent with disclosed embodiments. Together, FIGS. 4A, 4B, and 4C make up the whole flow diagram. The flow diagram in FIGS. 4A, 4B, and 4C includes three main operations: cash distribution 420, settlement 421, and amortization 422. Cash distribution 420, as described herein, may refer to payment of cash to, for example, an investor, customer, other individual, or entity from, for example, a fund, security, account, or company, including dividends, interest payments, proceeds from the sale of assets. In various embodiments, money paid out in cash distribution 420 may be paid out on a monthly, quarterly, or annual basis, or based on some other period.

In one embodiment, for cash distribution 420, product benefits hub (PBH) 438 may consume an average daily loan value for each loan. PBH 438, as described herein, may refer to a centralized platform for receiving, storing, managing, directing, or transmitting financial data, such as loan data across systems, components, or processes. Average daily loan value, as described herein, may refer a concept used for calculating loans or assessing fees based on the average outstanding balance over a period of time, where a company may keep track of a loan's outstanding balance at the end of each day, add the balances together, and divide by the number of days in the period of time. The period of time may be one day, one week, one month, or some other amount of time. Average daily loan value may impact the amount of interest charged or be used to calculate a minimum payment due for a period of time. Average daily loan value data for each loan may then be published to a general statement balances topic 450 in a third-party service provider 105, as described with respect to FIG. 2, such as modernization service provider 452. Modernization service provider 452, as described herein, may refer to a service provider, as described with respect to FIG. 2, tasked with modernization of core banking systems or managing revenue, new product offerings, products and pricing, or customer experience. Statement balances topic 450, as described herein, may refer to a Kafka topic 451 used for containing account data on account, statement, or loan balance. Kafka topic 451, as described herein, may refer to a named container for storing and organizing messages or streams of data. In some embodiments, Kafka topic 451 may act as a log of events where new messages or data is appended to the end. In some embodiments, there may be several systems reading data from or writing data to Kafka topic 451, and in other embodiments, there may be only one system reading data from or writing data to Kafka topic 451 at a time. Kafka topic 451, as described herein, may refer to Kafka topics generally rather than one Kafka topic in particular and therefore may be used to label several components in FIGS. 4C, 5C, 6C, and 7C.

Modernization service provider 452 may include integration ingress processor 453 for loan statement balances and integration ingress processor 543 may read statement balances topic 450 and save that data into service fabric layer 454. Integration ingress processor 453, as described herein, may refer to an input point that reads records from one or more Kafka topic 451. Service fabric layer 454, as described herein, may refer to a distributed systems platform that may facilitate the packaging, deployment, and management of microservices and data to allow for seamless flow of data. Microservices, as described herein, may refer to a software architecture style where applications are built as a collection of small, independent, and loosely couples services, each running its own process and being organized around particular functions and objectives. Service fabric layer 454 may perform data transformation and ensure data quality. Data transformation, as described herein, may refer to converting, cleaning, or structuring data for analysis, reporting, or storage. Service fabric layer 454 may enable applications to be deployed at a rapid pace and may maximize computing power, storage, and efficiency to run several applications at once. Modernization service provider 452 may have rewards calculator 455 that may periodically determine a customer's applicable rewards for loans and save that data into service fabric layer 454. Rewards calculator 455, as described herein, may refer to a system for determining a cash back rewards a customer should receive based at least on data received from service data fabric 454 including data contained in statement balance 450. Rewards calculator 455 may comprise a processor, input device, or output device. In some embodiments, rewards calculator 455 may use predefined rules, equations, or algorithms to determine a cash back reward. The predefined rules, equations, and algorithms may include considerations of, for example, the principal of the loan, repayment history, the entity's relationship with the lender, how long the entity has been a customer of the lender, or how early the entity executes a payment before a due date. The predefined rules, equations, and algorithms may be the same for each entity or may change based on the entity. Rewards calculator 455 may use one or more methods for determining the cash back reward. In some embodiments, rewards calculator 455 may determine a cash back reward based on the customer relationship. In other embodiments, rewards calculator 455 may use the relationship score, relationship score history, or average relationship score over a period of time to calculate the cash back reward. In other embodiments, rewards calculator 455 may use the principal of the loan to determine a cash back reward.

Integration egress processor 456 may receive data on a customer's applicable rewards for loans from service fabric layer 454. Integration egress processor 456, as described herein, may refer to an output point that transmits data or records to one or more Kafka topic 451. Integration egress processor 456 may periodically publish rewards to customer rewards topic 457. Customer rewards topic 457, as described herein, may refer to a Kafka topic 451 used for containing customer rewards data for applicable loans.

PBH 438 may monitor customer rewards topic 457 to check if customer rewards topic 457 received data that requires processing. In some embodiments, monitoring may include probing for data, sending queries, or performing periodic data collection. PBH 438 may house a job processor service, which may include rewards job processor 450 and rewards aggregate job processor 441, that may allow PBH 438 to process the rewards fulfillment in a resilient fashion. In some embodiments, job processing may be asynchronous. Job processing may be asynchronous when the job processing service is capable of starting a job without the entity, as described with respect to FIG. 1, having to wait for it to finish. The entity may receive notice, which may include a reference number, that the job has begun and may continue other work while the job is processed in the background. Asynchronous job processing may need three components: job producer, job processor service, and job posting exception service. The job producer may be any service which creates job requests of a specific type and posts them to a job processor dedicated to processing them. Job types may describe the purpose for the job. The job processor may require that every job it processes have a specific job type. In some embodiments, the job processor may be able to handle jobs of multiple types. A job processor service, as described herein, may refer to a software framework used to handle and manage data, documents, or transactions. A job processor service may work to process simple or complex tasks efficiently, accurately, and in compliance with a job request. Tasks may include, for example, verifying information, compiling documents or data, processing cash back rewards, or managing workflows related to loans. Job processor services may accept asynchronous job requests of a specific type and may offer four guarantees. First, job processor services may guarantee that no jobs will be lost. The job processor service may guarantee that a job posted to it by a job producer will be persisted to its dedicated job database before being queued and before running a success status back to the job producer. This may ensure that a posted job is not lost, even if the job processor service instance which originally received the job crashes before or during the job's execution. Second, job processor services may guarantee that all jobs will be executed. The job processor service may guarantee that it will execute a job either immediately upon receipt, at a deferred time specified by the job producer in its request, or upon retrying to post a job. Third, job processor services may guarantee that a job will not be run simultaneously by separate threads. A thread, as described herein, may refer to a sequence of instructions that the computing device's, as described with respect to FIG. 2, processor, as described with respect to FIG. 3, can execute. The job processor service may guarantee that a job is executed by only one thread at a time, never in parallel with multiple threads. Executing a job by one thread at a time may improve simplicity, predictability, and data integrity. Fourth, job processor services may guarantee that all job states and events will be logged. Job states may include states such as PENDING, PENDING_RETRY, PROCESSING, COMPLETED, FAILED, EXPIRED, CANCELED, ORPHANED, or VOID. Job processor services may guarantee that all state changes and events associated with a job are logged in real-time in its dedicated job database so that a job's full lifecycle may be traced. A job posting exception service, as described herein, may refer to a service which retries the posting of job requests of a specific type which the job producer was unable to post to the job processor service due to circumstances where the job processing service was unavailable to receive them originally. The job posting exception service may make guarantees to the job producer. First, the job posting exception service may guarantee all job posting exceptions will eventually be posted to the job processor. The job posting exception service may guarantee that any jobs which the job producer is unable to post to the job processor service will be posted to the job processor service as soon as possible, once the job processor service is available again. Second, the job posting exception service may guarantee that all job posting retry attempts will be logged. The job posting exception service may guarantee that it will log every job posting retry attempt to its dedicated job database so that there is visibility into whether a job has successfully made it to the job processor service and when, or if, retry attempts are continuing. Rewards job processor 440 and rewards aggregate job processor 441, as herein described, may refer to job processor services related to loan cash back rewards and aggregate loan cash back rewards, respectively.

PBH 438 may determine the general ledger (GL) and the trans code that should be used for loan cash rewards. GL, as described herein, may refer to a central, organized record of all transactions an individual or entity makes. Trans code, as described herein, may refer to transaction code, which may be a numeric or alphanumeric code used to identify and categorize various transactions. Rewards job processor 440 may determine a customer's preferred demand deposit account (DDA). A DDA, as described herein, may refer to a high liquidity bank account, such as a checking account, savings account, or money market account. In other embodiments, the DDA may refer to a loan account. PBH 438 may call annual exempt amount (AEA) 435 to verify that the customer has a Compliance-to-Product (C2P) to their desired rewards account. This may be a part of system of record's (SOR) 458 zero trust policy. SOR 458, as described herein, may refer to a centralized information system that may be the primary location where data is created, stored, and managed, providing consistency and accuracy for entities and processes. PBH 438 may send the GL, transcode, and the customer's DDA account from rewards job processor 440 to cost of services (COS) 434 to post the funds to the customer's DDA account. COS 434, as described herein, may refer to a database storing information representing charges a company incurs for various operations. In some embodiments, the cash back reward may be automatically applied to the balance of the loan automatically.

PBH 438 may then record the reward fulfillment in PBH database 460 for future recollection and post the reward to data streaming platform (DSP) 430 and publish an event. In some embodiments, PBH database 460 may be a standard query language (SQL) server, such as a MSFT SQL server. Events, as described herein, may refer to specific occurrence within a system and may include an entity clicking a button, completion of a transaction, or the sending or receipt of data. DSP 430, as described herein, may refer to a system involved in capturing, processing, and analyzing data in real-time. DSP 430 may process data as it arrives, offering immediate insight and response. DSP 430 may have an event-driven architecture such that the sending or receiving of data or the happening of some other event may trigger a response. PBH database 460, as described herein, may be similar to database 315, as described with respect to FIG. 3. PBH's 438 rewards job processor 440 and rewards aggregate job processor 441 may monitor the customer's rewards benefits earned 461 and use data read from rewards benefits earned 461 to calculate the customer's rewards benefits earned aggregate 462 and their rewards unlocked. PBH's 438 rewards aggregate job processor 441 may log the aggregate and unlocked values in PBH database 460 and post the aggregate and unlocked values to DSP 430.

Settlement 421, as described herein, may refer to a process of transferring funds after a payment transaction has been authorized and cleared. In some embodiments, extract-transform-load (ETL) processes 439 may be used to perform nightly batch settlement reconciliation 436. ETL processes 439, as described herein, may refer to automated processes of taking raw data, performing data transformation, and loading the information to a data warehouse, such as enterprise data warehouse (EDW) 437, or some other target location for analysis or reporting. EDW 437, as described herein, may refer to a centralized repository that may combine data from various sources to facilitate data analysis and decision-making. In some embodiments, EDW 437 may store data, such as financial data, entity statement balance information, cash back reward computations, and cash back reward log. Cash back reward computations, as described herein, may refer to the method used by the rewards calculator during each period for determining cash back rewards for the entity and a substance of those computations. Cash back reward log, as described herein, may refer to a record of all cash back rewards issued to an entity. In some embodiments, EDW 437 or the rewards system, as described with respect to FIG. 2, may use the data EDW 437 receives to feed back into future cash back rewards computations. In some embodiments, EVL 436, a data repository and processing program, may be used to assist with this process by allowing use of certain service providers 105, as described with respect to FIG. 2, to handle operations such as payment processing. Nightly batch settlement reconciliation 436, as described herein, may refer to a process of grouping and processing all transactions from a day, or some other set period, at the same time to facilitate fund transfers and reconciliation. Reconciliation, as described herein, may refer to a process of comparing internal accounting records to bank statements to ensure balances match. Reconciliation may help identify discrepancies, errors, omissions, or inaccuracies.

In some embodiments, PBH 438 may send GL entries file 463 to certified fraud examiner (CFE) 432 for hard posting the customer's funds and may also send reconciliation file 464 down to floating rate note/reverse convertible note (FRN/RCN) 433 on a nightly basis. GL entries file 463, as described herein, may refer to a file containing data representing accounts and transactions in a general ledger. CFE 432, as described herein, may refer to a professional who specializes in identifying, investigating, and preventing fraud within companies, ensuring the integrity of financial operations. Reconciliation file 464, as described herein, may refer to a file containing data that verifies the accuracy of financial records against its bank statement. FRN/RCN 463, as described herein, may refer to a debt instrument with an interest rate that adjusts periodically based on a benchmark interest rate. In another embodiment, FRN/RCN 463 may refer to a structured investment product, combining characteristics of both bonds and stocks, offering a fixed return through interest payments while exposing investors to risk of an underlying asset.

Amortization 422, as described herein, may refer to a process of reducing the balance of a debt through regular payments made over a period of time. In some embodiments, PBH 438 may send transactions file 465 to EDW 437 to get the loan on record so that the bonus cash rewards can be amortized. Transactions file 465, as described herein, may refer to a file containing data about a specific class of transactions, such as loans. In some embodiments, EVL 436, a data repository and processing program, may be used to assist with the amortization process by allowing use of certain service providers 105, as described with respect to FIG. 2, to handle operations such as payment processing.

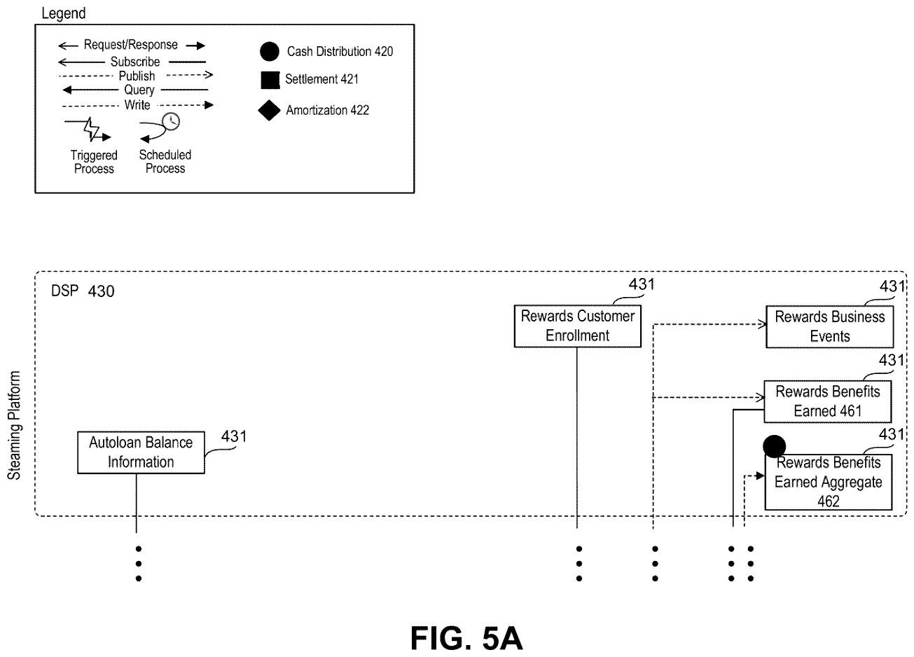

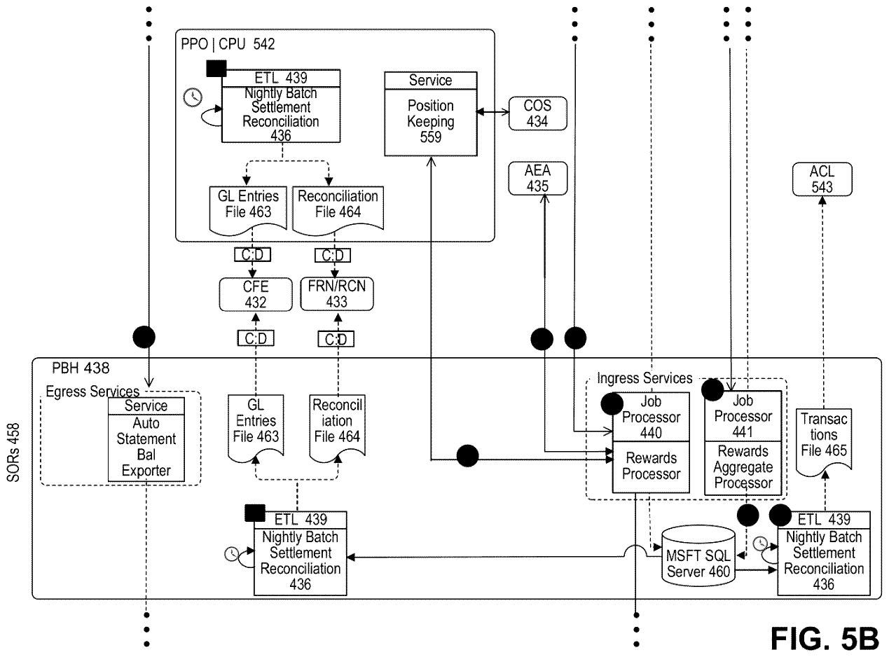

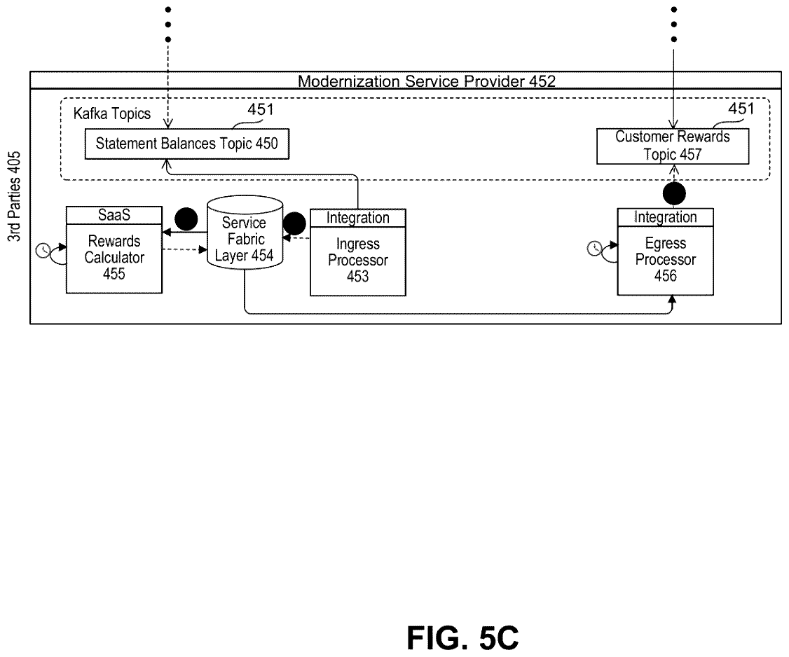

Each of FIGS. 5A, 5B, and 5C depict a portion of another flow diagram for providing cash back rewards on loans, such as automobile loans, consistent with disclosed embodiments. Together, FIGS. 5A, 5B, and 5C make up the whole flow diagram. The flow diagram in FIGS. 5A, 5B, and 5C comprises three main operations: cash distribution 420, settlement 421, and amortization 422. Terms used in the description of FIGS. 5A, 5B, and 5C assume their respective descriptions as described herein with respect to FIGS. 2, 3, 4A, 4B, and 4C.

In one embodiment, for cash distribution 420, PBH 438 may consume an average daily loan value for each loan. Average daily loan value data for each loan may then be published to a general statement balances topic 450 in a third-party service provider 105, such as modernization service provider 452. Modernization service provider 452 may have integration ingress processor 453 for loan statement balances, and integration ingress processor 453 may read statement balances topic 450 and save that data down into service fabric layer 454. Modernization service provider 452 may have a rewards calculator 455 that may periodically determine a customer's applicable rewards for loans and save that data into service fabric layer 454. Integration egress processor 456 may receive data on a customer's applicable rewards for loans from service fabric layer 454. Integration egress processor 456 may periodically publish rewards to customer rewards topic 457.

PBH 438 may monitor customer rewards topic 457 to check if customer rewards topic 457 received data that requires processing. PBH 438 may house a job processor service, which may include rewards job processor 440 and rewards aggregate job processor 441 that may allow PBH 438 to process the rewards fulfillment in a resilient fashion. PBH 438 may determine the GL and the trans code that should be used for loan cash rewards. Rewards job processor 440 may determine a customer's preferred DDA. PBH 438 may call AEA 435 to verify that the customer has a C2P to their desired rewards account. This may be a part of SOR's 158 zero trust policy. PBH 438 may send the GL, transcode, and the customer's DDA account from rewards job processor 440 to proximal policy optimization central processing unit (PPO|CPU) 542 to post the funds to the customer's account. PPO|CPU 542, as described herein, may refer to a central processing unit with a reinforcement learning algorithm capable of training a neural network to make decisions in an environment. PPO |CPU 542 may adjust decision-making to maximize rewards or improve performance. COS 434 may also post to position keeping 559 as part of its normal money movement processes. DSP topic 431, as described herein, like Kafka topic 451, may refer to a named container for storing and organizing messages or streams of data. DSP topic 431, as described herein, may refer to DSP topics generally rather than one DSP topic in particular and therefore may label multiple components in FIGS. 4A, 5A, 6A, and 7A. Position keeping 559, as described herein, may refer to a platform that manages financial instrument movements. Position keeping 559 may maintain data relating to the status of positions, which may be securities, commodities, or currency held by an individual or entity.

PBH 438 may then record the reward fulfillment in PBH database 460 for future recollection and post the reward to DSP 430 and publish an event. PBH's 438 rewards job processor 440 and rewards aggregate job processor 441 may monitor the customer's rewards benefits earned 461 and use data read from rewards benefits earned 461 to calculate the customer's rewards benefits earned aggregate 462 and their rewards unlocked. PBH's 438 rewards aggregate job processor 441 may log the aggregate and unlocked values in PBH database 460 and post the aggregate and unlocked values to DSP 430.

In some embodiments, for settlement 421, ETL processes 439 may be used to perform nightly batch settlement reconciliation 436. In some embodiments, EVL 436 may be used to assist with this process. In some embodiments, PBH 438 may send GL entries file 463 to CFE 432 for hard posting the customer's funds and may also send reconciliation file 464 down to Floating Rate Note/Reverse Convertible Note (FRN/RCN) 433 on a nightly basis. PPO|CPU 542 may also send GL entries file 463 and hard post entries to CFE 432 for hard posting the customer's funds. PPO|CPU 542 may also send a reconciliation file 464 down to FRN/RCN on a nightly basis.

In some embodiments, for amortization 422, PBH 438 may send transactions file 465 to allowance for credit losses (ACL) 543. ACL 543, as described herein, may refer to a contra-asset account used by a company to estimate or account for possible losses on their loan portfolio. ACL 543 may represent funds set aside to cover anticipates losses that have not been realized yet.

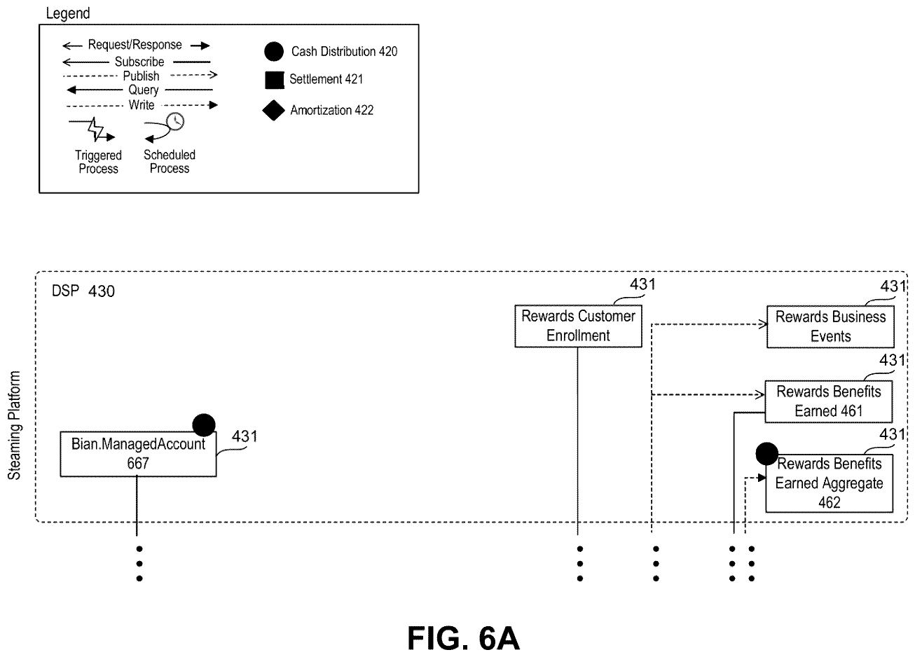

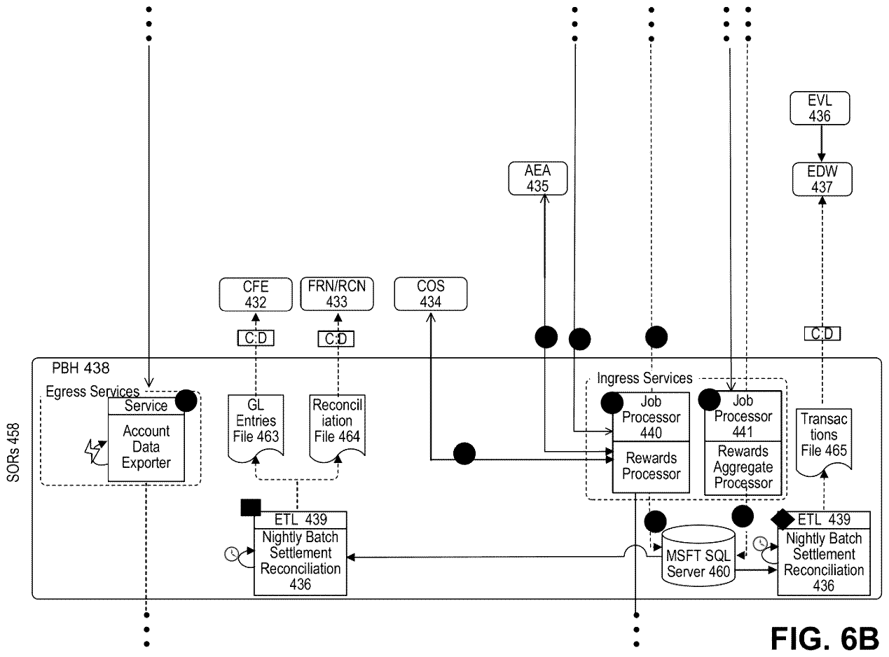

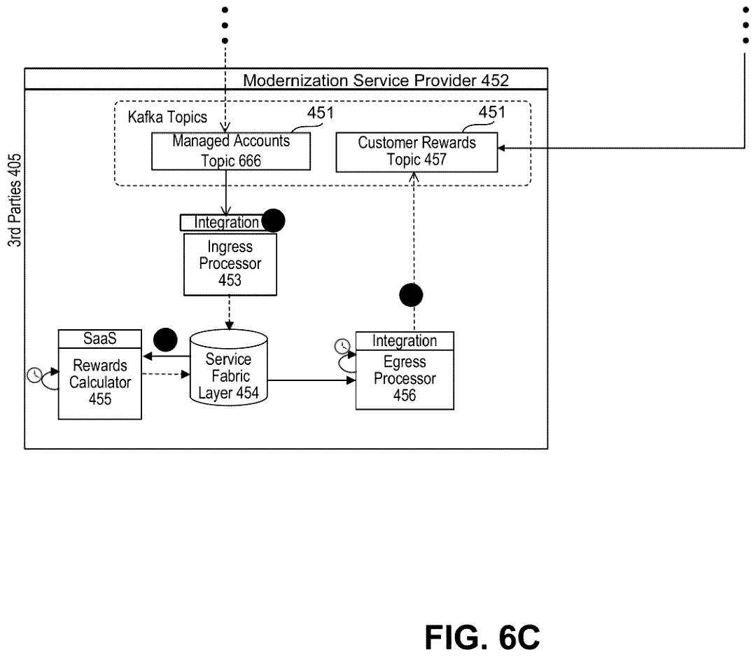

Each of FIGS. 6A, 6B, and 6C depict a portion of a flow diagram for providing cash back rewards on loans, such as home equity line of credit (HELOC) or mortgage loans, consistent with disclosed embodiments. Together, FIGS. 6A, 6B, and 6C make up the whole flow diagram. The flow diagram in FIGS. 6A, 6B, and 6C comprises three main operations: cash distribution 4204, settlement 421, and amortization 422. Terms used in the description of FIGS. 6A, 6B, and 6C assume their respective descriptions as described herein with respect to FIGS. 2, 3, 4A, 4B, and 4C.

In one embodiment, for cash distribution 420, managed accounts topic 666 may be changed to add an acquisition code for average daily loan balance information. Managed accounts topic 666, as described herein, may refer to a Kafka topic 451 used for containing data on loan accounts managed by a company or lender. Managed accounts topic 666 may inform modernization service provider 452 of the entity's average loan balance and any account funding. Modernization service provider 452 may have an integration ingress processor 453 for loan data and save that loan data into service fabric layer 154. Modernization service provider 452 may have rewards calculator 455 that may periodically determine a customer's applicable rewards for loans and save that data into service fabric layer 454.

Loan account data may be received along with general account data about customers via BIAN. ManagedAccount 667. BIAN, as described herein, may refer to the banking industry architecture network, a global, non-profit organization focused on developing digital standards and best practices for companies, such as financial institutions. BIAN. ManagedAccount 667, as described herein, may refer to a DSP topic 431 used for containing data on loan accounts and the entities or individuals who own the accounts. In some embodiments, such data may include information on whether the account originated with a specific company, was purchased, or if service of the account was transferred from one company to another. Integration egress processor 456 may periodically publish rewards to customer rewards topic 457. In some embodiments, a customer must maintain good standing with the lender and be in the process of paying the loan off to be eligible to receive cash back on loan funding events. The customer may get cash back posted to their DDA on loan funding data plus a probationary period. Until then, the reward may show up as pending. Once the probationary period is over, the reward may show up as posted as a reward.

As a part of eligibility determination, the company may send down customer and account information about its customers. As a part of that data, modernization service provider 452 may look for loan origination and, after some determined period of time, post the customer's cash back reward based on the customer's enrolled tier.

PBH 438 may monitor customer rewards topic 457 to check if customer rewards topic 457 received data that requires processing. PBH 438 may house a job processor service, including rewards job processor 440 and rewards aggregate job processor 441, that may allow PBH 438 to process the rewards fulfillment in a resilient fashion. PBH 438 may determine the general ledger and the trans code that should be used for loan cash rewards. Rewards job processor 440 may determine the customer's preferred DDA account. PBH 438 may call AEA 435 to verify that the customer has a C2P to their desired rewards account. This may also as a part of SOR's 458 zero trust policy.

PBH 438 may send the GL, transcode, and the customer's DDA account to COS 434 to post the funds to the customer's account. PBH 438 may record the reward fulfillment in the PBH database 460 for future recollection and may post the reward to DSP 430 and publish an event. PBH's 438 rewards job processor 440 and rewards aggregate job processor 441 may monitor the customer's rewards benefits earned 461 and use data read from rewards benefits earned 461 to calculate the customer's rewards benefits earned aggregate 462 and their rewards unlocked. PBH's 438 rewards aggregate job processor 441 may then log the aggregate and unlocked values in the PBH database 460. Rewards aggregate job processor 441 may also post the aggregate and unlocked values to DSP 430.

In some embodiments, for settlement 421, ETL processes 439 may be used to perform nightly batch settlement reconciliation 436. In some embodiments, PBH 438 may send GL entries file 463 to CFE 432 for hard posting the customer's funds and may send reconciliation file 464 to FRN/RCN on a nightly basis.

In some embodiments, for amortization 422, PBH 438 may send transactions file 465 to EDW 437 to get the loan on record so that the bonus cash rewards may be amortized. In some embodiments, EVL 436 may be used to assist with the amortization process.

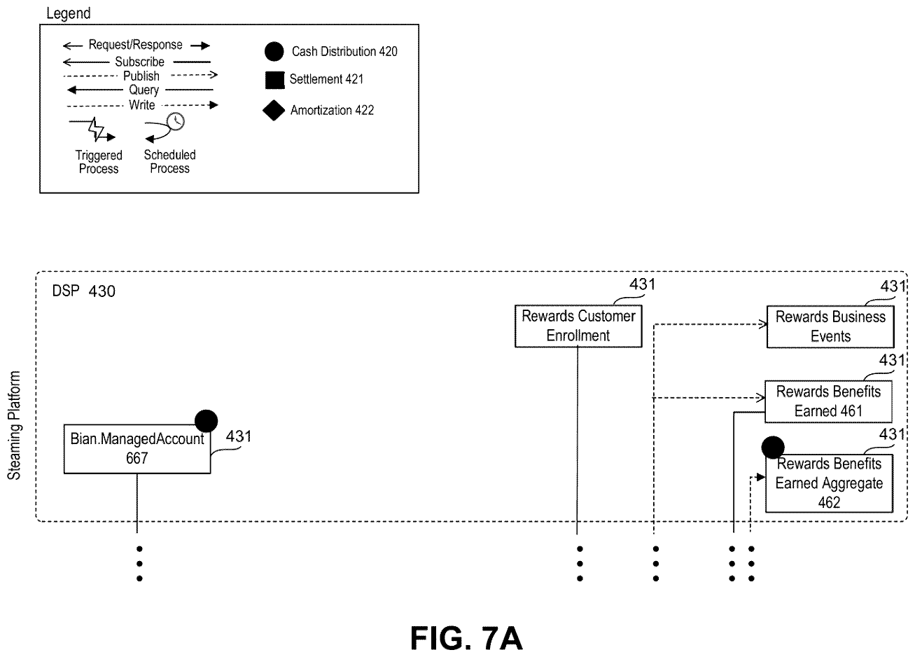

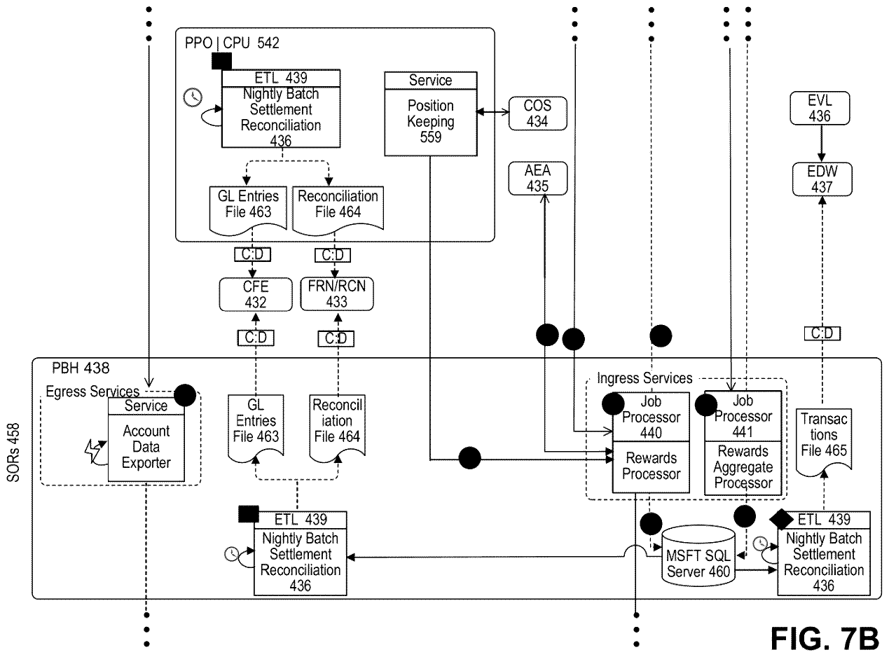

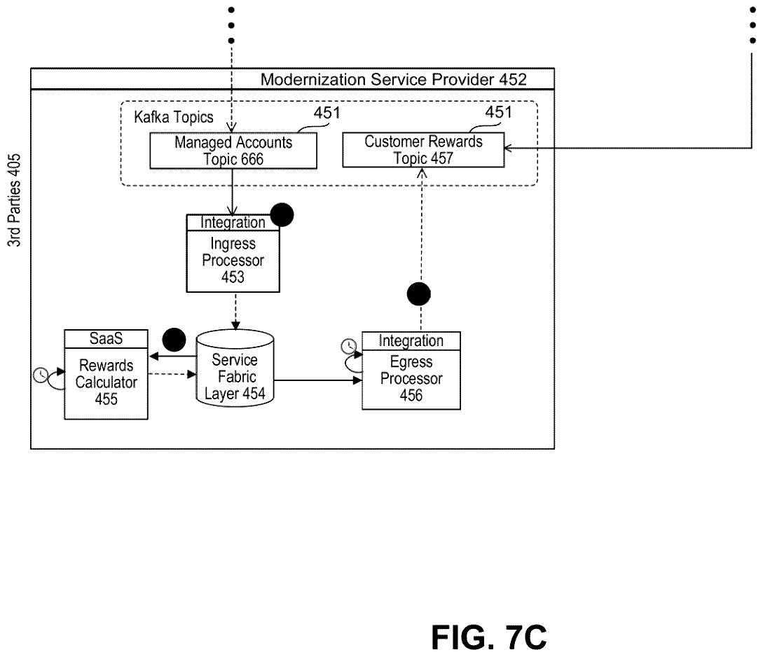

Each of FIGS. 7A, 7B, and 7C depict a portion of another flow diagram for providing cash back rewards on loans, such as HELOC or mortgage loans, consistent with disclosed embodiments. Together, FIGS. 7A, 7B, and 7C make up the whole flow diagram. The flow diagram in FIGS. 7A, 7B, and 7C comprises three main operations: cash distribution 420, settlement 421, and amortization 422. Terms used in the description of FIGS. 7A, 7B, and 7C assume their respective descriptions as described herein with respect to FIGS. 2, 3, 4A, 4B, 4C, 6A, 6B, and 6C.

In one embodiment, for cash distribution 420, managed accounts topic 666 may be changed to add an acquisition code for average daily loan balance information. Managed accounts topic 666 may inform modernization service provider 452 of the customer's average loan balance and any account funding. Modernization service provider 452 may have an integration ingress processor 453 for loan data and save that loan data into service fabric layer 454. Modernization service provider 452 may have rewards calculator 455 that may periodically determine a customer's applicable rewards for loans and save that data into service fabric layer 454.

Loan account data may be received along with general account data about customers via BIAN. ManagedAccount 667. Integration egress processor 456 may periodically publish rewards to customer rewards topic 457. In some embodiments, a loan customer must maintain good standing with the lender and be in the process of paying the loan off to be eligible to receive cash back on loan funding events. Good standing, as described herein, may mean the customer meets all account terms, such as making timely payments, avoiding overdrafts, and not exceeding credit limits. The customer may get cash back posted to their DDA on loan funding data plus a probationary period. Until then, the reward may show up as pending. Once the probationary period is over, the reward may show up as posted as a reward.

As a part of eligibility determination, the company may send down customer and account information about its customers. As a part of that data, modernization service provider 452 may look for loan origination and, after some determined period of time, post the customer's cash back reward based on the customer's enrolled tier.

PBH 438 may monitor customer rewards topic 457 to check if customer rewards topic 457 received data that requires processing. PBH 438 may house a job processor service, including rewards job processor 440 and rewards aggregate job processor 441, that may allow PBH 438 to process the rewards fulfillment in a resilient fashion. PBH 438 may determine the general ledger and the trans code that should be used for loan cash rewards. Rewards job processor 440 may determine the customer's preferred DDA account. PBH 438 may call AEA 435 to verify that the customer has a C2P to their desired rewards account. This may also be a part of SOR's 458 zero trust policy.

PBH 438 may send the GL, transcode, and the customer's DDA account to PPO |CPU 542 to post the funds to the customer's account. COS 434 may also post to position keeping 559 as part of its normal money movement processes. PBH 438 may record the reward fulfillment in the PBH database 460 for future recollection and may post the reward to DSP 430 and publish an event. PBH's 438 rewards job processor 440 and rewards aggregate job processor 441 may monitor the customer's rewards benefits earned 461 and use data read from rewards benefits earned 461 to calculate the customer's rewards benefits earned aggregate 462 and their rewards unlocked. PBH's 438 rewards aggregate job processor 441 may then log the aggregate and unlocked values in the PBH database 460. Rewards aggregate job processor 441 may also post the aggregate and unlocked values to DSP 430.

In some embodiments, for settlement 421, ETL processes 439 may be used to perform nightly batch settlement reconciliation 436. In some embodiments, PBH 438 may send GL entries file 463 to CFE 432 for hard posting the customer's funds and may send reconciliation file 464 to FRN/RCN 433 on a nightly basis. PPO |CPU 542 may send GL entries file 463 and hard post entries to CFE 432 for hard posting the customer's funds and may send reconciliation file 464 to FRN/RCN on a nightly basis.

In some embodiments, for amortization 422, PBH 438 may send transactions file 465 to EDW 437 to get the loan on record so that the bonus cash rewards can be amortized. In some embodiments, EVL 436 may be used to assist with the amortization process.

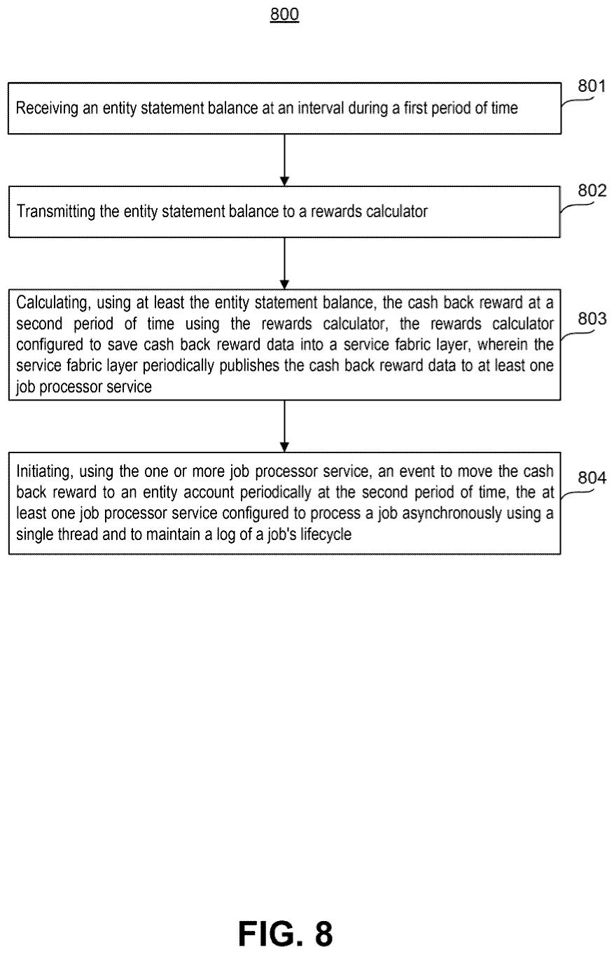

FIG. 8 depicts a method 800 of issuing cash back rewards. As depicted in FIG. 8, method 800 may include a variety of steps. Terms used in the description of FIG. 8 assume their respective descriptions as described herein with respect to FIGS. 2-7. The embodiment in FIG. 8 is merely illustrative. As depicted in FIG. 8, method 800 may include a step 801 of receiving an entity statement balance at an interval during a first period of time. The interval, as described herein, may be hourly, daily, weekly, monthly, or some other periodic recurrence. Method 800 may include a step 802 of transmitting the entity statement balance to a rewards calculator. Method 800 may include a step 803 of calculating, using at least the entity statement balance, the cash back reward at a second period of time using the rewards calculator, the rewards calculator configured to save cash back reward data into a service fabric layer, wherein the service fabric layer periodically publishes the cash back reward data to at least one job processor service. In some embodiments, an entity may be assigned a relationship score based on the entity's relationship with a company or lender. The relationship score may be based on, for example, how long the entity has been a customer of the company or lender. In some embodiments, the cash back reward may be calculated using the relationship score. In other embodiments, the cash back reward may be calculated based on an entity's cash back rewards tier. The entity's cash back rewards tier, as described herein, may be one or more levels that the entity reaches during the course of repaying a loan or maintaining good standing with the company or lender, where the entity may receive more cash back at higher tiers as they continue to repay the loan. In other embodiments, the cash back reward may be calculated based on when the entity makes a payment between the first period of time and the second period of time. The entity may receive additional cash back when the entity makes a payment early. In some embodiments, the rewards calculator may determine a rate of decline of the entity statement balance over a preselected period of time. In related embodiments, the cash back reward may not be issued if the rate of decline of the entity statement balance is below a preselected threshold rate of decline. Method 800 may include a step 804 of initiating, using the at least one job processor service, an event to move the cash back reward to an entity account periodically at the second period of time, the at least one job processor service configured to process a job asynchronously using a single thread and to maintain a log of a job's lifecycle. In some embodiments, entity statement balance information, cash back reward computations, and cash back reward log may be recorded into a data warehouse.

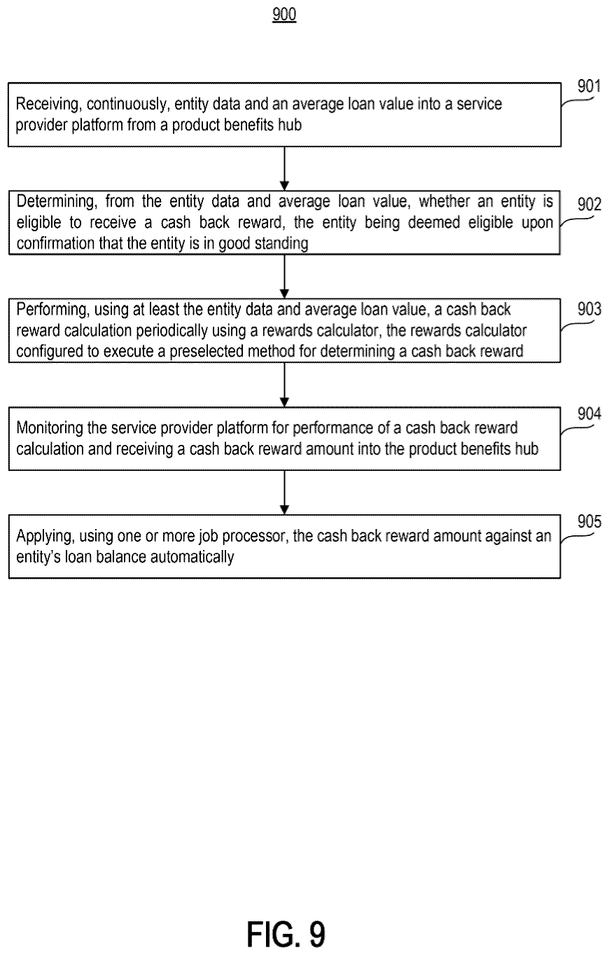

FIG. 9 depicts a method 900 of issuing cash back rewards. As depicted in FIG. 9, method 900 may include a variety of steps. Terms used in the description of FIG. 9 assume their respective descriptions as described herein with respect to FIGS. 2-8. The embodiment in FIG. 9 is merely illustrative. As depicted in FIG. 9, method 900 may include a step 901 of receiving, continuously, entity data and an average loan value into a service provider platform from a product benefits hub. Entity data, as described herein, may refer to identifying information; account data, such as financial data or history, for an account associated with the entity, loan data, or any other data associated with the entity. Method 900 may include a step 902 of determining, from the entity data and average loan value, whether an entity is eligible to receive a cash back reward, the entity being deemed eligible when the entity maintains good standing. Method 900 may include a step 903 of performing, using at least the entity data and average loan value, a cash back reward calculation periodically using a rewards calculator, the rewards calculator configured to execute a preselected method for determining a cash back reward. In some embodiments, the average loan value may be an average daily loan value. In some embodiments, the cash back reward calculation may be performed hourly, daily, weekly, monthly, or some other periodic recurrence. In some embodiments, an entity may be assigned a relationship score based on the entity's relationship with a company or lender. The relationship score may be based on, for example, how long the entity has been a customer of the company or lender. In some embodiments, the cash back reward may be calculated using the relationship score. In some embodiments, a reinforcement learning algorithm may be used to maximize the cash back reward amount. In some embodiments, the service provider platform may determine a rate of decline of the entity's loan balance over a preselected period of time. In related embodiments, the cash back reward may not be issued if the rate of decline of the entity's loan balance is below a preselected threshold rate of decline. Method 900 may include a step 904 of monitoring the service provider platform for performance of a cash back reward calculation and receiving a cash back reward amount into the product benefits hub. In some embodiments, entity statement balance information, cash back reward computations, and cash back reward log may be recorded into a data warehouse. Method 900 may include a step 905 of applying, using one or more job processor, the cash back reward amount against an entity's loan balance automatically.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware or by software on any operating system of any firmware, or by a combination thereof. For example, as hardware, selected steps of the disclosure may be implemented as a chip or a circuit. As software or algorithm, selected steps of the disclosure may be implemented as a plurality of software instructions being executed by a computer using any suitable operating system. In any case, selected steps of the method and system of the disclosure may be performed by a data processor, such as a computing device for executing a plurality of instructions.

Although the present disclosure is described with regard to a “computing device,” it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a “network” or a “computer network.”

To provide for interaction with a user, the systems and techniques described herein can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back-end component (e.g., as a data server), or that includes a middleware component (e.g., an application server), or that includes a front end component (e.g., a client computer having a graphical user interface or a web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

The block diagrams in the figures illustrate the architecture, organizational entity, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the organizational entity involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

1.-20. (canceled)

21. A system for providing an entity a cash back reward on a loan, comprising:
at least one processor configured to execute instructions to:
receive, continuously, entity data and an average loan value into a service provider platform from a product benefits hub;
determine, from the entity data and average loan value, whether an entity is eligible to receive a cash back reward, the entity being deemed eligible when the entity maintains good standing;
perform, using at least the entity data and average loan value, a cash back reward calculation periodically using a rewards calculator, the rewards calculator configured to execute a preselected method for determining a cash back reward;
monitor the service provider platform for performance of a cash back reward calculation and receiving a cash back reward amount into the product benefits hub; and
apply, using one or more job processor, the cash back reward amount against an entity's loan balance automatically.

22. The system of claim 21, wherein the cash back reward calculation is performed on a monthly basis.

23. The system of claim 21, wherein the entity is assigned a relationship score based on an entity's relationship with a company.

24. The system of claim 23, wherein the relationship score is based on how long the entity has been a customer of a company.

25. The system of claim 23, wherein the cash back reward is calculated based on the entity's relationship score.

26. The system of claim 21, wherein the average loan value is a daily average loan value.

27. The system of claim 21, wherein a reinforcement learning algorithm maximizes the cash back reward amount.

28. The system of claim 21, wherein the service provider platform determines a rate of decline of the entity's loan balance over a preselected period of time.

29. The system of claim 28, wherein the cash back reward is not issued if the rate of decline of the entity's loan balance is below a preselected threshold rate of decline.

30. The system of claim 21, wherein at least entity statement balance information, cash back reward computations, and cash back reward log are recorded into a data warehouse.

31. A computer implemented method for providing an entity a cash back reward on a loan, the method comprising the following operations performed by one or more processors:
receiving, continuously, entity data and an average loan value into a service provider platform from a product benefits hub;
determining, from the entity data and average loan value, whether an entity is eligible to receive a cash back reward, the entity being deemed eligible when the entity maintains good standing;
performing, using at least the entity data and average loan value, a cash back reward calculation periodically using a rewards calculator, the rewards calculator configured to execute a preselected method for determining a cash back reward;
monitoring the service provider platform for performance of a cash back reward calculation and receiving a cash back reward amount into the product benefits hub; and
applying, using one or more job processor, the cash back reward amount against an entity's loan balance automatically.

32. The method of claim 31, wherein the cash back reward calculation is performed on a monthly basis.

33. The method of claim 31, wherein the entity is assigned a relationship score based on an entity's relationship with a company.

34. The method of claim 33, wherein the relationship score is based on how long the entity has been a customer of a company.

35. The method of claim 33, wherein the cash back reward is calculated based on the entity's relationship score.

36. The method of claim 31, wherein the average loan value is a daily average loan value.

37. The method of claim 31, wherein a reinforcement learning algorithm maximizes the cash back reward amount.

38. The method of claim 31, wherein the service provider platform determines a rate of decline of the entity's loan balance over a preselected period of time.

39. The method of claim 38, wherein the cash back reward is not issued if the rate of decline of the entity's loan balance is below a preselected threshold rate of decline.

40. A non-transitory computer storage medium encoded with computer program instructions that when executed by one or more processors, cause the one or more processors to perform operations for providing an entity a cash back reward on a loan, the operations comprising:
receiving, continuously, entity data and an average loan value into a service provider platform from a product benefits hub;
determining, from the entity data and average loan value, whether an entity is eligible to receive a cash back reward, the entity being deemed eligible when the entity maintains good standing;
performing, using at least the entity data and average loan value, a cash back reward calculation periodically using a rewards calculator, the rewards calculator configured to execute a preselected method for determining a cash back reward;
monitoring the service provider platform for performance of a cash back reward calculation and receiving a cash back reward amount into the product benefits hub; and
applying, using one or more job processor, the cash back reward amount against an entity's loan balance automatically.
